(19) United States
(12) Patent Application Publication
(10) Pub. No.: US 2016/0026640 A1
(43) Pub. Date: Jan. 28, 2016

(54) SYSTEMS AND METHODS OF TESTING-BASED ONLINE RANKING

(71) Applicant: Attune, Inc., Los Gatos, CA (US)

(72) Inventors: Michael Hart, Los Gatos, CA (US); Guoning Hu, Fremont, CA (US)

(73) Assignee: ATTUNE, INC., Los Gatos, CA (US)

(21) Appl. No.: 14/806,624

(22) Filed: Jul. 22, 2015

Related U.S. Application Data
(60) Provisional application No. 62/028,226, filed on Jul. 23, 2014.

(51) Int. Cl. G06F 17/30

(52) U.S. Cl. CPC G06F 17/3053; G06F 17/3089

(57) ABSTRACT

The technology disclosed relates to web analytics and, in particular, to testing user reactions to alternative browser or web application presentations. Some implementations present a selected, ordered set of images. The position and ordering of individual images can be significant to user response. Some implementations adapt a background, motif, or image set based on a requesting user's preferences, such as a color preference. The technology disclosed simplifies test implementation, so that a few lines of code can be added to a web app to invoke the test platform and obtain operational parameters that shape a user's experience.

### PRIORITY DATA

The application claims the benefit of U.S. Provisional Patent Application No. 62/028,226, entitled, “Systems and Methods of Testing-Based Service Fee Calculation, Billing and Auditing,” filed on 23 Jul. 2014. The provisional application is hereby incorporated by reference for all purposes.

### BACKGROUND

The technology disclosed relates to web analytics and, in particular, to testing user reactions to operational parameters for web app presentations. One or more operational parameters for transferring data for a test session are established. Operation of computers connected through a network is observed for responses to the operational parameters.

It can be very cumbersome to test alternative web app presentations. Different displays can involve different code bases. Transmission of one presentation or the other to test and control users can be difficult to manipulate in a test, when all of the users are accessing the same URI or URL.

An opportunity arises to develop better methods of deploying tests and success monitors, to evaluate user reactions and ongoing success of presentations. Comparative testing can be conducted to vet new concepts. Accepted concepts can occasionally be compared to baseline strategies to gauge ongoing reactions and to reestablish baselines.

Particular aspects of the technology disclosed are described in the claims, specification and drawings.

### SUMMARY

The technology disclosed relates to web analytics and, in particular, to testing user reactions to alternative browser or web application presentations. Some implementations present a selected, ordered set of images. The position and ordering of individual images can be significant to user response. Some implementations adapt a background, motif, or image set based on a requesting user's preferences, such as a color preference. The technology disclosed simplifies test implementation, so that a few lines of code can be added to a web app to invoke the test platform and obtain operational parameters that shape a user's experience. Particular aspects of the technology disclosed are described in the claims, specification and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1A illustrates a block diagram of an example environment in which the testing technologies disclosed herein can be used.

FIG. 1B is a block diagram of the major components of the testing technologies disclosed herein.

FIG. 2 shows an exemplary information flow diagram for the testing service in accordance with a platform implemented using the technology disclosed.

FIG. 3 shows an exemplary message sequence that shows a sequence of temporal interactions necessary to execute the ranking of objects.

FIGS. 4A and 4B provide an example of testing alternative selections of content used to introduce a visitor to a new or infrequently viewed content category.

FIG. 5 is an example of summary results from an AB test using ranking to order the test items.

FIG. 6 is a flowchart of the example given in FIGS. 4 and 5.

FIGS. 7, 8, 9, and 10 are example webpages and result summary for an email campaign.

FIG. 11 is a flowchart of the testing and ranking process used in the example in FIGS. 7, 8, 9, and 10.

FIG. 12 shows an example flowchart of the user ID binding and allocation process.

FIGS. 13A and 13B show example data structures used in the flowchart of FIG. 12.

FIGS. 14 and 15 show examples of user activity data captured for use in building the ranking models.

### DETAILED DESCRIPTION

The following detailed description is made with reference to the claims. Sample implementations and embodiments are described to illustrate the technology disclosed, not to limit its scope, which is defined by the claims. Those of ordinary skill in the art will recognize a variety of equivalent variations on the description that follows.

The technology disclosed relates to applying web analytics to online services. The technology disclosed is necessarily implemented by a computer-implemented system such as a network-based environment, a database system, or the like, because it involves testing reactions to computer-based presentations. This technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

The technology described isolates presentation item ranking and testing from web site development and deployment. A web developer can identify a factor to be tested, inserts a few lines of code into an app to pass parameters or a reference to the parameters to be tested, receives (and optionally logs) updated parameters, and uses the updated parameters to deliver content. Presentation items are ranked, test parameters are modified and the test results can be analyzed by a ranking or testing service. The service can rank items and modify presentation parameters the before the app formats the presentation, which effectively isolates ranking and testing from presentation aspects of the app code.

As a non-limiting example, consider a test involving placement of images on a page. The order in which images appear impacts user click-through responses and reactions generally, especially when only the first few images appear above the fold and are visible without navigation. The service disclosed ranks and tests alternative placements of images according to a test design, which includes a ranking model.

In one implementation, the testing service receives an ordered list of items to feature and information about the ultimate user who will be responding to the images as a test subject. According to the plan, the testing service determines whether the user will view images in the initial ordering or will receive an improved ordering. An improved ordering takes advantage of information about the user to revise the ordering and improve the user's experience and prompt interest in the most prominently featured items. Depending on the test or control decision, the testing service, running on a ranking server or workstation, returns an ordered list of the items in either the initial ordering or the improved ordering. The web app server uses the returned list just as it would have used a list without a testing option, minimizing any coding impact on code that formats data to be displayed to the ultimate user.

The testing service optionally can identify to the web app server, for logging or test monitoring, the test condition in the returned ordered list. Identification of the test condition with the returned ordered list allows the operator of the web app server to verify how the test is being conducted and to log test stimulus. This logging aside, the primary test logging and analysis can be managed by the testing service, which tends to isolate the test from operation of the deployed web app, thereby reducing operational impacts of testing.

The testing service records each sample point, including the test or control stimulus and user identification data to correlate stimulus with test results. The test results are supplied by the web app server or other external data source, to be correlated with the recorded stimulus and analyzed. The test results can include viewing time, click through and/or conversion data. The test results are an objective record of user behavior after the stimulus. The test results can include both further navigation of the ultimate user in the session using the returned list is used and return activity by the ultimate user in additional sessions within a specified or predetermined period.

Test list ordering performed by the ranking server can be done in real time or as pre-ordering of items for an email campaign or other distribution. In a real time implementation, the ultimate user requests content from the app server, which contacts the ranking server or testing service, which returns a list or other display parameter that is either a control or a reordered list.

In an email campaign, a single proposed list of items to feature can be accompanied by many user ids (hundreds, thousands, tens of thousands or more). Or, each user id can be accompanied by a list. Each user ID is assigned to either a “control” group or a “test” group. This assignment process is referred to as “allocation.” An initial or control list ordering is used for the control list used for the control group and a test list having improved ordering is used for the test group. Item ordering can be customized by group or by individual.

Test stimulus manipulation by a testing service, isolated from formatting, can impact other display features such as color theme or motif. For color theme, a list of colors can be considered by the test server in light of the user ID. The testing service can determine whether a particular instance should be a control or test. For test samples, as opposed to control samples, a color theme can be selected and returned, optionally accompanied by a test flag that identifies the test stimulus applied. Similarly, for a motif, the user ID can be used, in test instances, to select a test motif to be used in display to the ultimate user. As above, the testing service later matches test samples to results provided by the web app server and its related services.

Intermediate results can be evaluated as the test proceeds. Real time feedback can be evaluated, allowing a user or system to alter the test stimulus in real time while keeping the control stimulus constant. The larger the system, the more quickly a significant body of results accumulates and the more real time the evaluation and test modification can be. For instance, the test stimulus can be modified based on these intermediate results to improve performance lift metrics produced by a vendor's black box ranking algorithm. In some applications, a vendor's compensation for their ranking algorithm may be tied to the performance lift metrics.

The calculation of performance metrics based on results of presentations to users can be performed on an absolute or incremental basis. Metrics, including web site “stickiness”, can be measured and calculated in terms of average viewing time per browsing session per visitor, the average number of pages viewed per visitor or the average number of repeat visits per visitor to a site in a given time period. Another measure of effectiveness is the elapsed time or percentage rate for conversion of user interest into a transaction, from when a visitor lands on the website to when they leave. Other metrics can involve conversion in return visits in a given time period. If desired, multiple metrics may be included. Multiple variables, related to the presentation and/or user characteristics, can be tracked to provide a multivariate comparison between a control case and multiple test cases.

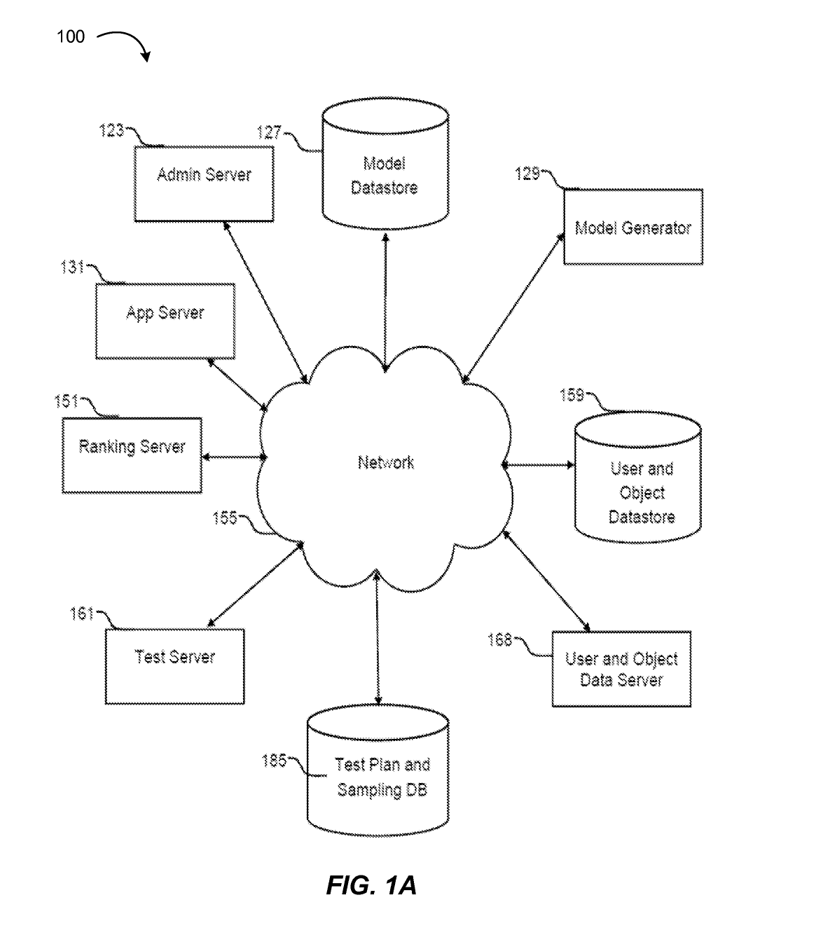

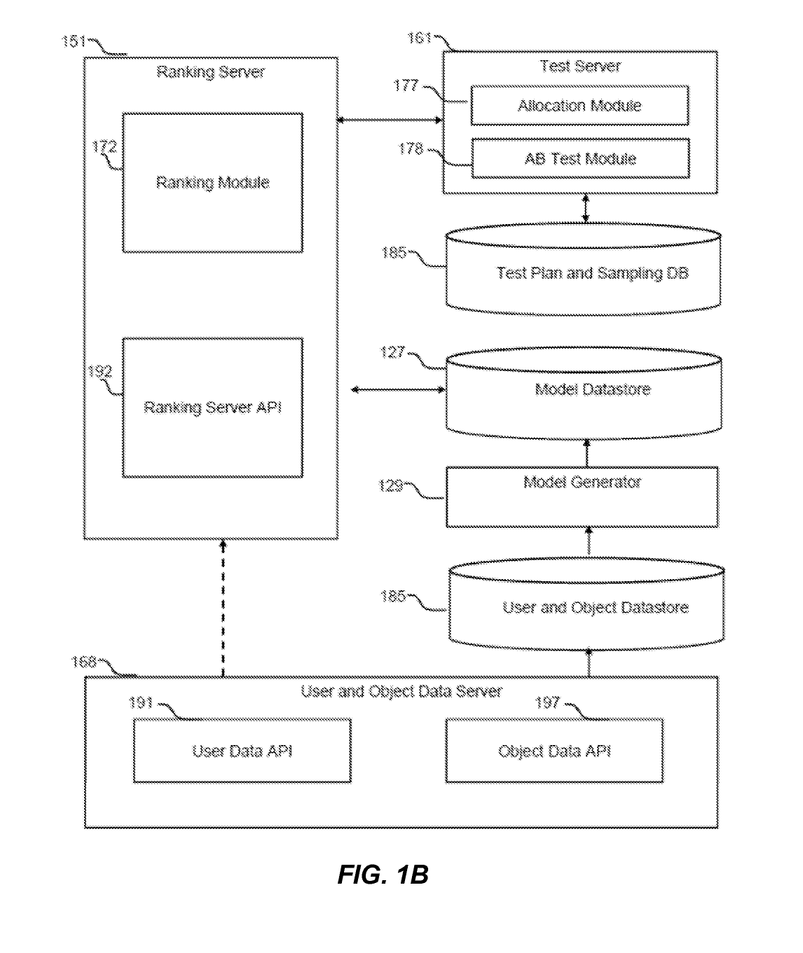

FIG. 1A illustrates a block diagram of an example environment 100 in which the technology disclosed can be used. In other implementations, environment 100 may not have the same elements or components as those listed above and/or may have other/different elements or components instead of, or in addition to, those listed above, such as a communication logger, proximity metric, or introduction trigger. The different elements or components can be combined into single software modules and multiple software modules can run on the same hardware.

The illustrated environment includes a ranking server 151 that ranks objects or items based upon input parameters received from app server 131. The input includes a user identifier. The ranking server 151 can source user data, indicating user preferences or from which user preferences can be inferred, from sources other than app server 131, based on the user ID. In some implementations, the ranking server can be of varying types including a workstation, server, computing cluster, blade server, server farm, or any other data processing system or computing device. The ranking server can be communicably coupled to the databases via a different network connection. For example, ranking server can be coupled via the network 155 (e.g., the Internet) or to a direct network link. The ranking server can be a recommender system, using a computer-implemented recommendation apparatus such as collaborative filtering, content-based filtering, hybrid recommender system, mobile recommender system, risk-aware recommender system, multi-criteria recommender system or any combination of the algorithms used by BellKor's Pragmatic Chaos team to win the 2009 Netflix Prize. Additional targeting algorithms described, identified or referred to in US 2014/0040008 A1 also may be implemented by the ranking server. It is expected that additional ranking approaches will be developed that remain compatible with the technology disclosed.

A model datastore 127 stores the models used by the ranking server to rank objects. A model generator 129 utilizes data from the user and object datastore 159 to generate models to effectively rank objects. A user and object data server 168 uses its own API to accept input from multiple sources including web server, third party, external and offline data. Datastores can be relational database management systems (RDBMSs), object oriented database management systems (OODBMSs), distributed file systems (DFS), no-schema database, or any other data storing systems or computing devices.

A test server 161 uses data provided by the test plan and sampling DB 185 to allocate users to control and test cells. The test server 161 also performs other tasks related to AB testing and multivariate testing, such as analyzing results and producing test reports, including real time or near real time reports. An administrative server 123 is included to provide system wide management and capabilities, including reading and writing data to the datastores and databases. The app server 133 can be a web server that runs applications to deliver web pages or a web application server that runs applications and interacts with a mobile application to deliver content to a mobile app.

Communication network 155 that allows communication between various components of the environment 100. Network(s) 155 can be any one or any combination of Local Area Network (LAN), Wide Area Network (WAN), WiFi, WiMax, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

Not shown is the ultimate user's application to which content is delivered by the app server. A user's application can take one of a number of forms, including user interfaces, mobile interfaces, tablet interfaces, summary interfaces, or wearable interfaces. In some implementations, it can be hosted on a web-based or cloud-based social application running on a computing device such as a personal computer, laptop computer, mobile device, and/or any other hand-held computing device. In one implementation, it can be accessed from a browser running on a computing device. The browser can be Chrome, Internet Explorer, Firefox, Safari, and the like. In other implementations, application can run in a window of a computer desktop application.

As further illustrated in FIG. 1B and explained below, the testing service can include a test server, a ranking server with a ranking service API, and a separate user and object server with its own API. In some implementations both servers can be supported by the same hardware or even by the same server software instance. The user and object server accepts input from multiple sources including web server, third party, external and offline data. Data may be received in continuous or batch mode. The ranking server can access the testing service or vice-a-versa, as those details are not apparent to the app server. The ranking server can operate when no test is active and track results of presentations, without comparing test and result stimuli.

Incoming data is validated and transformed by the user and object data server after which it is stored in the user and object data datastore.

The model generator utilizes the data in the user and object data datastore to generate models, stored in the model datastore, which can be used by the ranking server to effectively rank objects based upon inputs received from a app server via the ranking server API.

The ranking server ranks objects using a model responsive to input parameters received from an app server.

In one implementation of the technology disclosed, the testing service ranks objects by assigning users to test or control groups in cells of a test design. The assignment of users to a cell, with either a “test” or “control” ranking of items, is referred to as “allocation.”

A control cell is used as a reference for measuring one or more metrics associated with user activities involving the objects of interest. A test cell invokes a different item ranking than the control cell. The test design can include more than one test cell, in which case users are allocated to the control cell, some to a first test cell, others to a second test cell and so forth. Allocation to cells can be stratified by user characteristics, such as demographic characteristics and behavioral characteristics. Optionally, more than one control cell may be used to provide additional references.

The allocation of users may be performed on a random or statistical basis, according to a test plan. The test plan can take into account user demographics, preferences, etc. As an example, if a ten percent sample is desired for a specific test cell, then every tenth user may be allocated to that test cell. In another example, specific criteria including but not limited to gender, age, location or previous activity history may be used to assign a user to a particular test cell, either to focus the test on a user sub-population or to stratify sampling.

The technology disclosed can be used with multivariate testing to rank and isolate the effects of a particular web service relative to other factors that may influence user behavior, thus allowing the other factors to be evaluated independently. An example of this would be a personalization service that optimizes the presentation of an online catalog. Users allocated to a control cell would receive a default, non-optimized version of the website. Users allocated to a multiplicity of test cells, each having a different personalized optimization, would receive specific versions optimized by the personalization service. Comparison of the number and amount of transactions per user generated from the test and control cells could be used to determine the effectiveness derived from the personalization service in multiple scenarios.

The results of the comparisons can be used to evaluate the different optimizations and as a basis for calculating and quantifying the impacts on user behavior. The comparisons can be run on an ongoing basis including daily, weekly, hourly or according to any other schedule. Calculations can be performed accordingly, thereby tracking the ongoing performance of a personalization service. This can provide useful insights on ranking and personalization. It can provide a measure of ranking performance, to which pay for performance can be tied. The testing technology described improves on available web log analytics or usage-based tools for evaluating online services which offer only one time or ad-hoc performance testing.

The technology disclosed leverages timestamped, chronological tracking of the activities of individual users. Some of the activity informs allocation of users to cells in a test design and ranking for the users. User activity after ranking can indicate the impact of test or control stimulus. Examination of the tracking information allows a client to verify the details of a transaction for auditing purposes as well as troubleshooting any problems that may occur.

Activity tracking information after ranked presentation of objects to users can yield critical insights into impact on outcomes of test and control rankings. For instance, variations in content attributes, like the placement and colors used in presenting product information, can be ranked and measured for their relative effectiveness in retaining existing website users and acquiring new ones. In more sophisticated analyses, variations in user interface or website navigation can be measured and ranked for effectiveness in terms of the number of clicks are required for a user to perform a particular activity like completing an online training session. Additionally, browsing behavior can be captured, including how much time a user spends viewing a web page, where the user positions the cursor on the web page, keystrokes, mouse clicks and other details that measure a user's interaction with a presentation.

Rankings and tracking information can also be used to calculate other metrics which reflect aspects of user behavior. As an example, when a user clicks on a presentation, the effectiveness of that presentation can be confirmed when a user completes a transaction involving the content of the presentation or finishes a related activity such as an online test that follows the presentation. Additionally, the resulting user activity records for a test group can be used to rank which elements of a presentation are most effective. Alternatively, the same records can be used in conjunction with control group records to validate or audit the incremental effectiveness of an online service providing object ranking.

FIG. 1B is a block diagram showing the major components of the testing technologies disclosed herein. The ranking server 151 can include a ranking server API 192 which accepts input parameters from the app server 131 that includes a list of objects or a reference to a list of objects. It also includes a ranking module 172 that can rank objects in an incoming list or reference to a list. The ranking server communicates with the test server 161 to obtain allocation information for one or more users specified in the input parameters sent by the app server 131. The test server 161 includes an allocation module that assigns a user to either a test or control group. It also includes an AB test module that controls the AB testing process, including starting, stopping and updating the tests. The test server communicates with the test plan and sampling database 185, which provides storage for test plans and sample stimulus during a test. In addition, reported post-stimulus actions of users can be retained in database 185.

The user and object data server 168 accepts data from the app server 131, third parties and other external sources. The data can include user activity tracking data, user demographics, user-indicated preferences, clickstreams, social media data, product data, location data and object data. The data can be sent in batches for increased efficiency. The data can be directed to the user data API 191 or the object data API 197. The user and object data server validates the incoming data and stores it in the user and object datastore 185 for use by the model generator 129. Optionally, incoming data may be stored in a cache accessible to the ranking server 192 for use in last minute updates to a model.

The model generator analyzes the data and incorporates the results into data models which it stores in the model datastore 127. The models can be represented using a wide variety of datasets which include feature vectors, matrix coefficients, weighting factors and graphs. Conventional models can be used with the technology disclosed. The ranking module 172 ranks an object list by retrieving the appropriate model for the incoming user and object parameters received by the ranking server API 192, and performing the model calculation using the model dataset and the incoming user and object parameters.

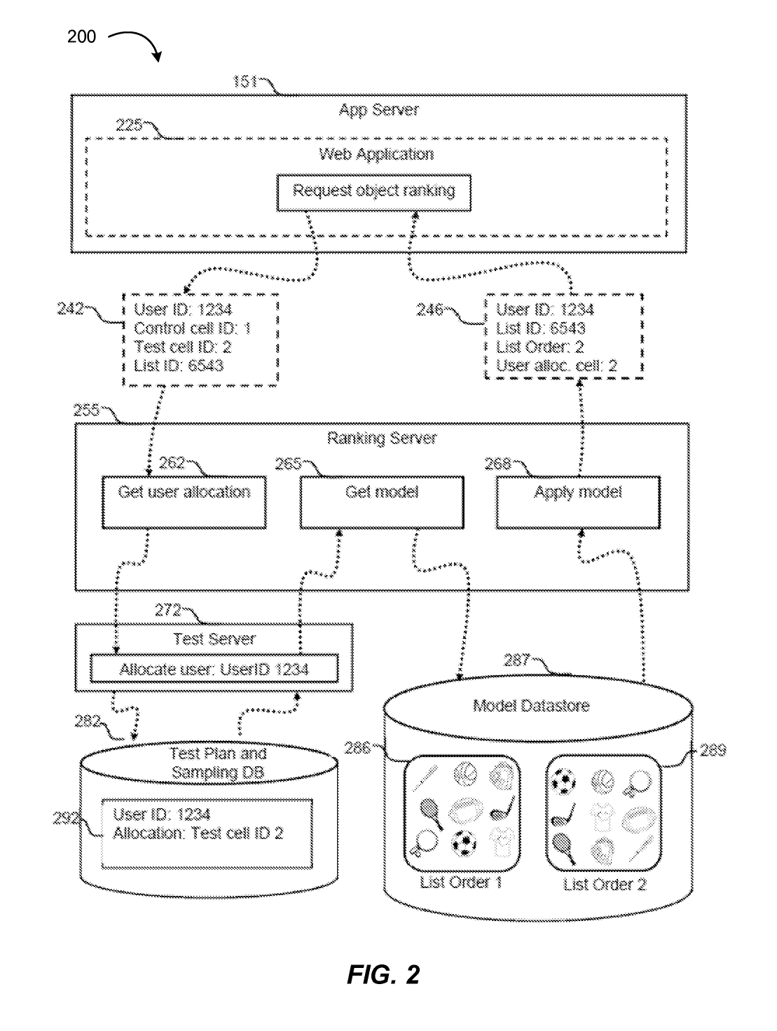

FIG. 2 shows an exemplary information flow diagram of how the ranking server 151 is connected into a web application 225 to provide control or test versions of objects and object lists to visitors to a website. Initially, the app server 131 passes user and object information 242 as input parameters to the ranking server 255. Typical input parameters can be categorized as user related, object related or display context related. User related parameters can include user ID, user profile and activity tracking data. Object related parameters can include lists of objects which can be passed explicitly or via reference, object attributes and their associated values. Display context can include attributes of the display with which the user interacts, such as device, screen size and resolution.

The ranking server sends input parameters to the test server 272 and requests it 262 to return the corresponding user allocation information 292. In one example implementation, the test server can access pre-allocated user IDs in the test plan and sampling database. In other implementations, the test server can allocate a user ID dynamically to an object ranking approach. When this information is received the corresponding model is requested 265 from the model database 287. To illustrate, two visual image orderings are shown, 286 and 289. The items in the list are sports implements being presented in different viewing orders. In this example, user ID 1234 was allocated to test cell ID 2 which corresponds to list order 2 as visualized at 289.

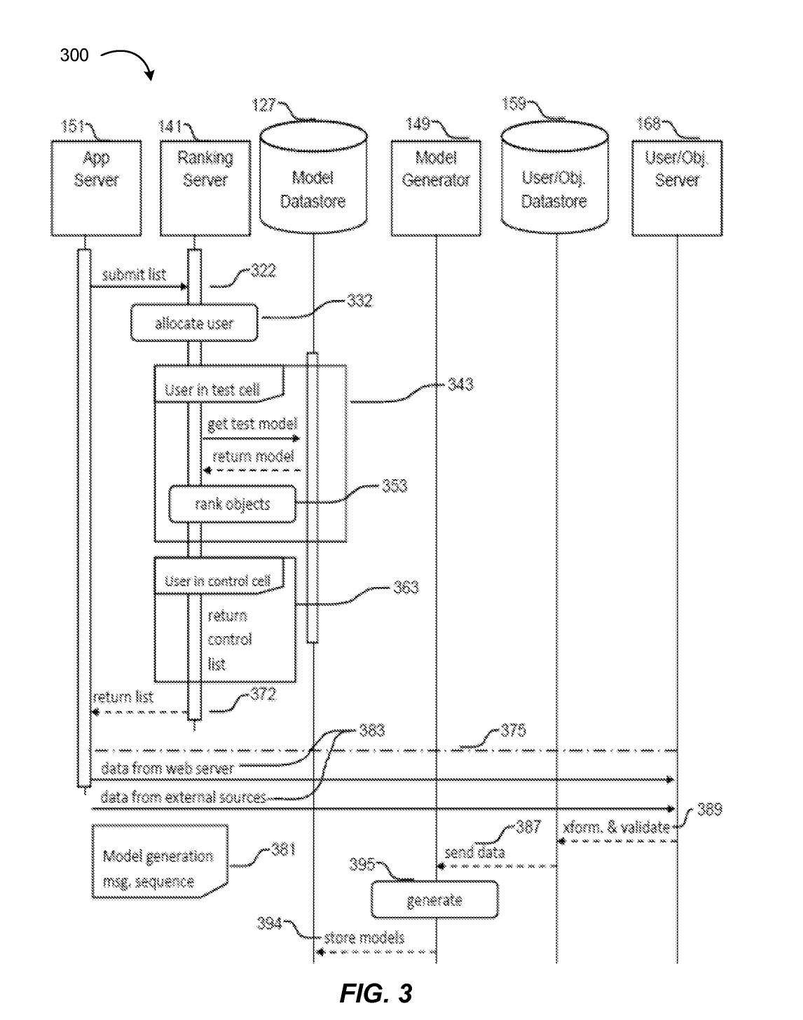

The models in the model database 287 can be generated by the model generator 129 as described in the message sequence 381 at the bottom of FIG. 3. The models may be generated based on any set of attributes relevant to the objects being ranked with respect to the intended users. For instance, if movies are being ranked, as in a more detailed example below, ranking attributes can include viewing frequency, viewer ratings, critic ratings, personal viewing history, content ratings and other recommendations. Other methods of combining object attributes and user related information may be used to generate object rankings can be combined with the technology disclosed by those skilled in the art.

The model in this example, producing results visualized as list order 2 at 289, is applied using parameters 242 supplied by the web app 225. Results 246 of applying the model are returned to the web app 225 for presentation to the ultimate user. The user's responses to the presentation can be monitored and recorded for later analysis by the testing service, to compare the performance of the test case against the control case or, more generally, to monitor the performance of a ranking service.

FIG. 3 is an example of a message sequence diagram that shows a sequence of interactions used to rank objects based on user data retrieved for a user ID supplied as an input parameter. In this diagram, solid arrows from left to right represent requests and dotted arrows from right to left represent responses. Time flows from the top of the diagram to the bottom. The entities across the top are the same as in FIG. 1A: app server 131, ranking server 141, model database 127, model generator 149, user and object datastore 159 and user and object server 168.

The app server 131 initiates the process at 322 by supplying parameters including user ID or other identity information and requesting a list of objects. The ranking server 141 accepts the request and obtains user allocation at 332 from the test server. Users allocated to a test cell are processed using sequence 343, which retrieves the test model from the model datastore 127, ranks the object list at 353 using the parameters supplied by the app server 131 and returns the improved list at 372. Users allocated to the control cell are processed using sequence 363, which returns the control object list to the app server at 372.

The sequence below the dashed line 375 is an example process used to generate models. At 383, data is sent to the user and object server 168 from the app server 131 and other external sources if present. The user and object server 168 validates the data and transforms it into a form that can be used by the model generator, then pushes it to the user and object datastore. The model generator 149 can now access the data and use it to generate models which are stored in the model datastore 127 for use by the ranking server.

### First Use Case

### Ranking Movies

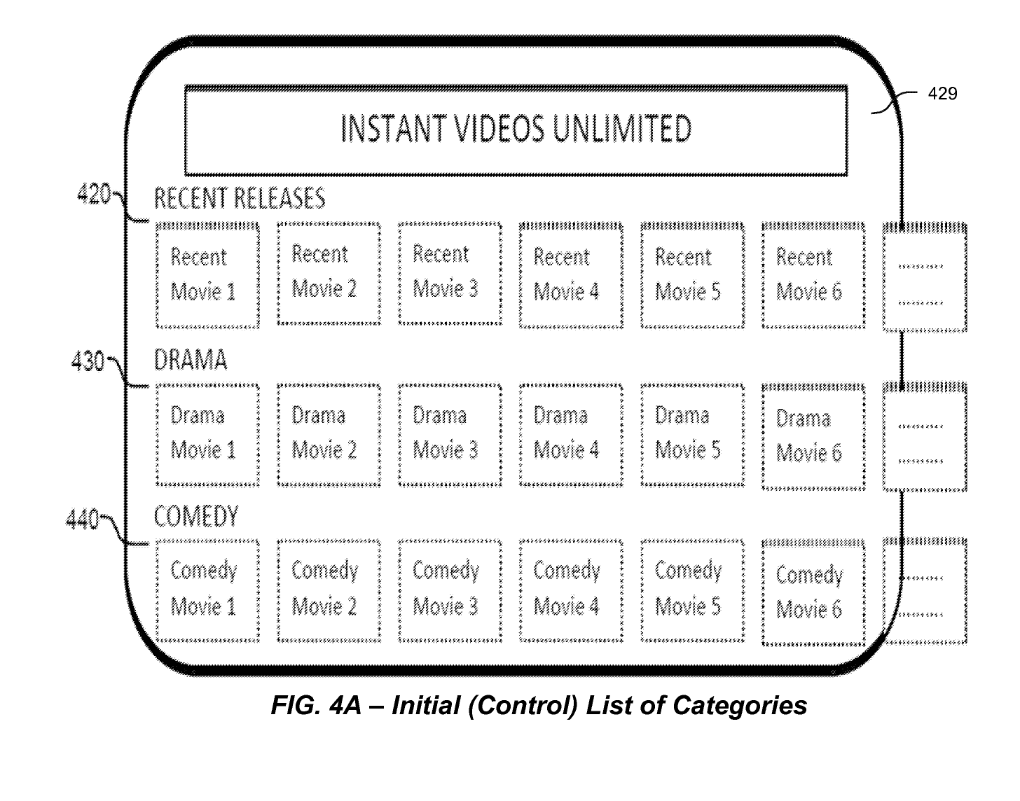

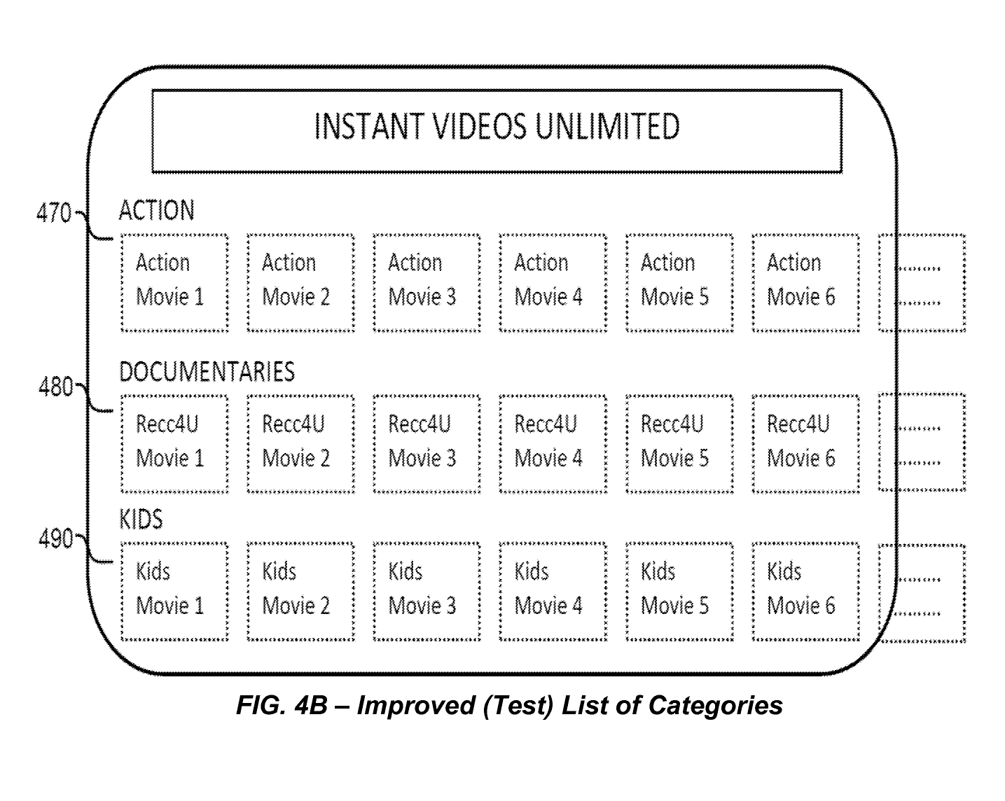

FIGS. 4A and 4B provide an example of testing alternative selections of content used to introduce a movie viewer to a content category that they have not viewed infrequently or not at all. The ranking server selects fresh content in an effort to expand the viewer's range of interests without irritating them, without causing them to leave the web site frustrated. Consider for instance an online video service showing movies organized into movie categories or genres 420, 430, 440, 470, 480 and 490. This example can be used to illustrate how to compare the effectiveness of two different approaches, a test case and a control case, to reducing subscriber churn by selectively introducing visitors to other categories they had not viewed or viewed infrequently.

A data driven approach to selecting personalized categories for a ranking approach under test scenario can be compared to a control case in which a list of top genres and movies is selected by a human being based on their judgment and intuition. Subsequent to selecting genres and movies expected to provide a more positive viewer experience, web analytics can also be used to track and measure the impact of both the control and test approaches on subscriber churn rate as a key indicator of effectiveness. as a corollary, a subscriber retention rate can be measured, which is 1-churn. Further, user behavior can be tracked both prior to a user visiting the movie web site and during their interaction with the web site. User tracking provides additional input to selecting categories and movies to recommend. User tracking provides a historical context and reference point to measure a visitor's behavioral change as reflected by their online activity.

Web analytics also can also analyze trends in a large population of users. For instance, given a larger sample size, ranking may be used within and across categories to discover the movies and genres most frequently viewed and those most highly rated by viewers. It can reflect how viewing is impacted critics' remarks and awards.

For personalization, ranking can take into account the past viewing history and preferences of individual visitors. Personalization of rankings may also include ratings, preferences and recommendations derived via social media including online friends or associates of a subscriber.

In this example, the default presentation order, also called sort order, displays movies for each category in a separate row with the most highly ranked movies on the left and the lower ranked movies towards the right. The rows can be scrolled horizontally to the left and right in this example to display an arbitrary number of movies in each category as indicated by the movie placeholders 429 in the rightmost column of the layout shown in FIG. 4A.

The control, or default, case for this scenario is that the movies and genres in FIG. 4A will be based on a list of top genres and movies selected by a human being (or editor) based upon their judgment of what is “best.”

In contrast to the control webpage FIG. 4A, the test case for this scenario FIG. 4B provides a personalized list of genres and movies in those genres. There are many ways to choose these. In this example, web analytics were applied to select genres and movies which have attributes similar to those based upon the user's viewing history. Movies can be classified into various genres and assigned particular descriptors which serve as attributes: drama, comedy, action, documentary, kids, science fiction, fantasy, reality, thriller, military, suspense, etc. Genre, attributes and descriptors of one movie can be compared to another. Additional attributes for which degrees of similarity can be determined include actors, directors, locale, historical period, themes, cinematic technique and content ratings.

For a user who watches reality-based dramas like the movie Hotel Rwanda, documentaries would be a potential choice since documentaries are by definition reality-based and include this classifier. If a user watches comedies then a good alternative may be kids' movies starring actors who also star in comedies the user has previously viewed. Rows 430 and 480 of the control webpage illustrate the control genres and movies as selected by an editor. These are contrasted with rows 440 and 490 of the personalized test webpage which features genres and movies dynamically selected and ranked in real time based on the user's viewing history and recent additions to their movie queue. Many other approaches to ranking and selecting movies and genres based on a visitor's viewing history are possible and will be familiar to those skilled in the art.

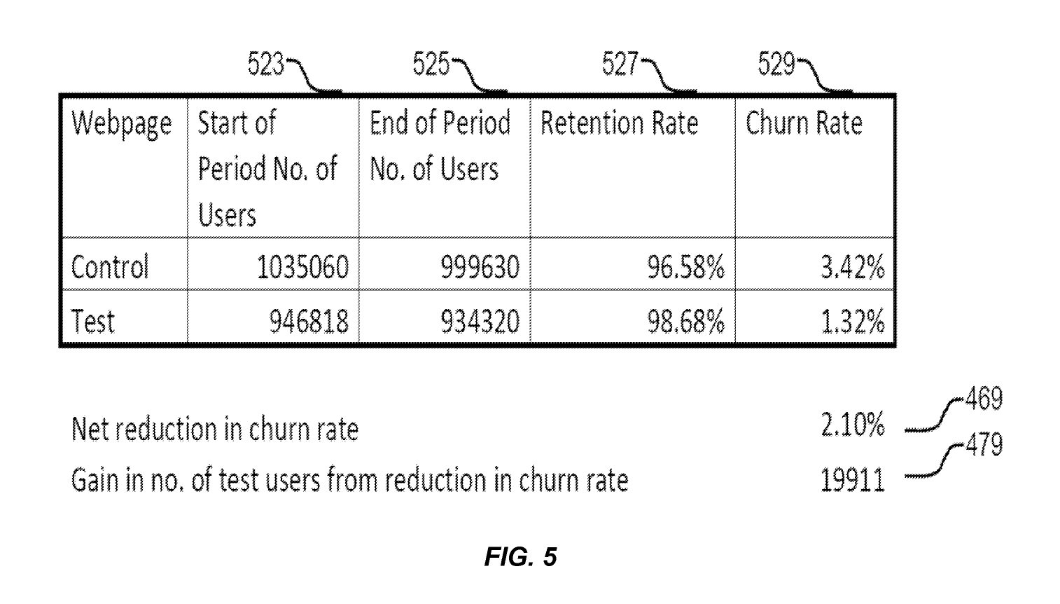

Once the control and test cases are defined as in FIGS. 4A and 4B, an AB test can be applied to this example. The results are summarized in the table given in FIG. 5 which shows that the subscriber churn rate was reduced 469 by 2.10% for the period being tested, yielding 19911 additional users retained 479. The retention rate was calculated as:

(no. users at start of period 523)/(no. users at end of period 525)

The churn rate 529 was calculated as one minus the retention rate 527:

churn rate=1−retention rate

All rates are expressed as percentages (multiply by 100).

Thus, the decrease in churn rate for the test users (or conversely, the increased retention rate) for this example is:

decrease in churn rate=3.42%−1.32%=2.10%

additional test users retained=2.10%*946818=19911

Retention of visitors will typically boost revenue to a measurable extent. Each retained visitor, not lost to churn, can be assigned a dollar value and a total revenue boost due to visitor retention calculated.

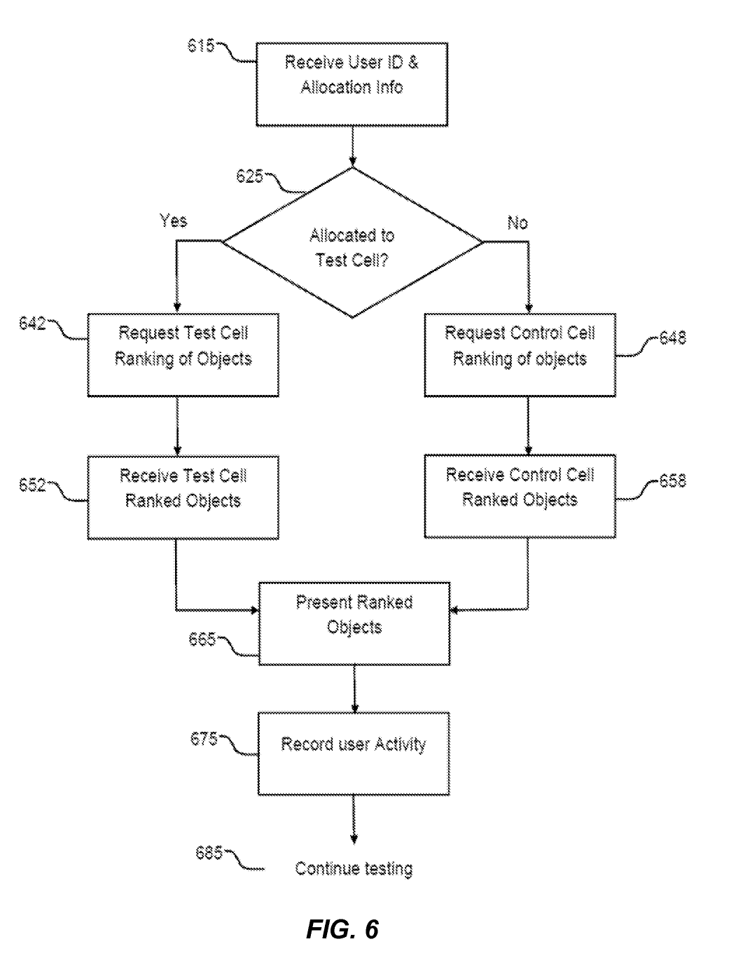

FIG. 6 is a flowchart of the example given in FIGS. 4 and 5. This flowchart applies object ranking to genres and movies for each user in this example.

The user ID and allocation information is received at 615 and from this it can be determined at 625 if the user is allocated to a test cell or a control cell. A list or set of ranked objects is then requested 642 or 648 from the ranking server 151 in FIG. 1A. The list is then ranked and can subsequently ordered or sorted according to the type of ranking corresponding to the user allocation: test ranking or control ranking.

For the control webpage in FIG. 4A in this example a ranked list of genres and ranked movies within those genres is requested, wherein the ranking is done by a human editor. For the test webpage in FIG. 4B, the requested list is ranked based on movies and genres having similar attributes to those found in a user's personal viewing history as described above. When the ranked list is received 652 or 658 from the ranking server 151, it is presented to the user 665 and the subsequent user activity is recorded at 675.

### Second Use Case

### Tents and Outdoor Equipment

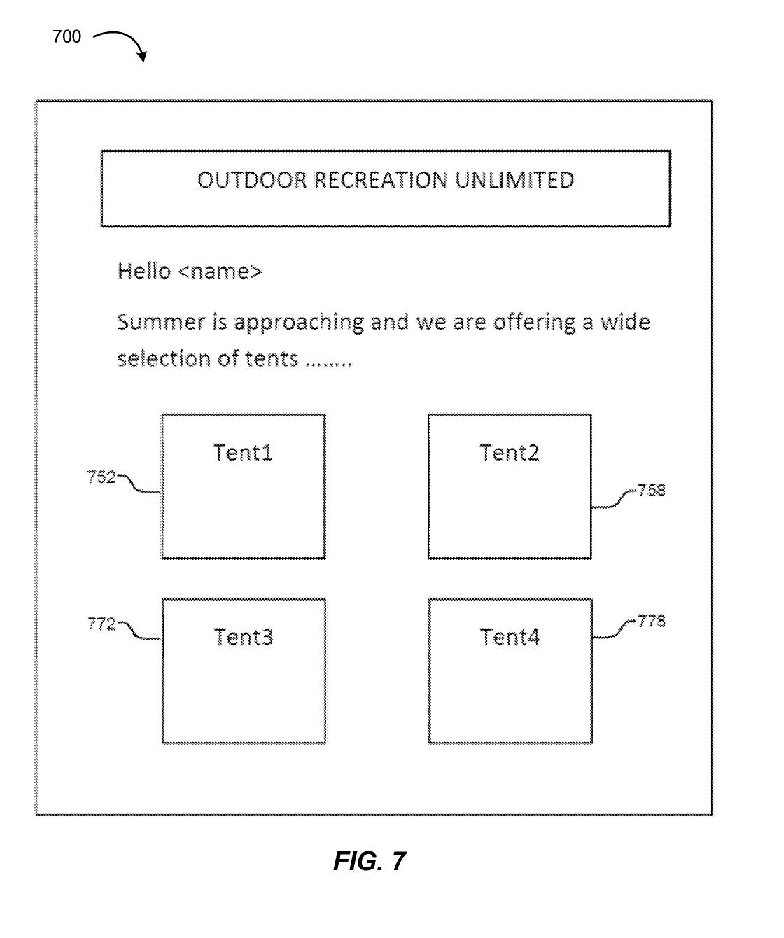

FIG. 7 is an example webpage 700 for an email campaign. In this application of ranking, an email campaign is being tested for effectiveness in new user acquisition. In this example an outdoor equipment provider is promoting tents as the summer camping season approaches by sending out emails in advance of the season.

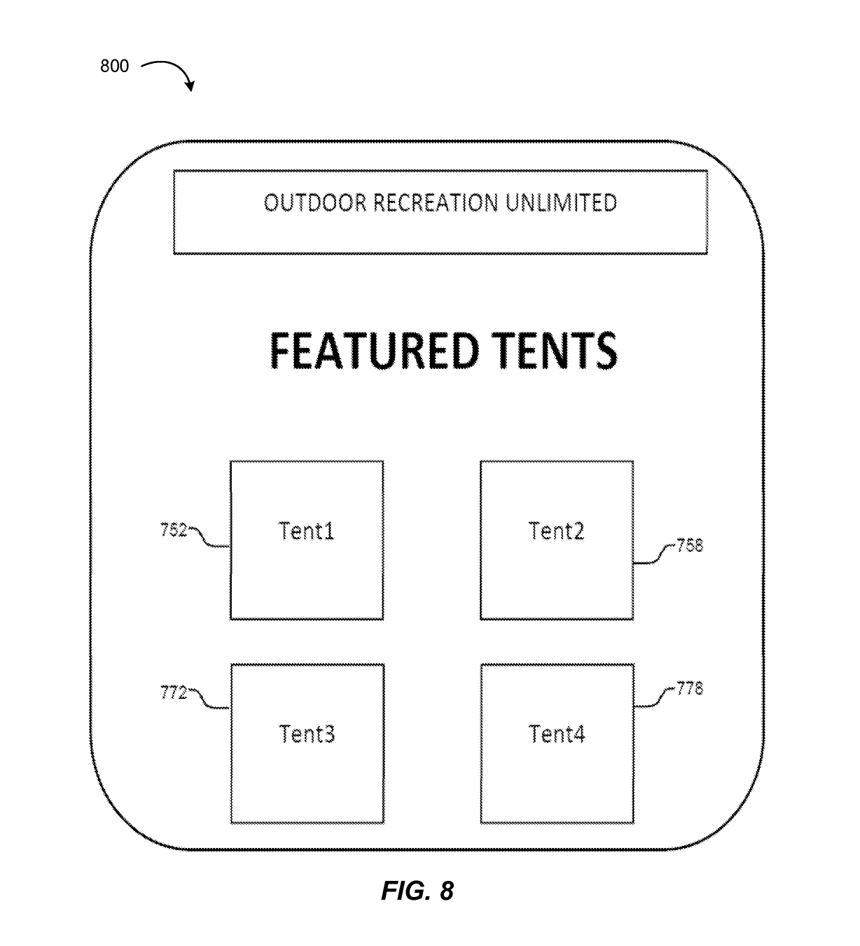

The email features a wide selection of tents including many options featured on a special webpage 800 in FIG. 8. In this example, four categories of tents are used: large car camping tents, outdoor shelters and tarps, four person backpacking tents and two person backpacking tents. For ease of explanation these categories will be referred to as Tent1, Tent2, Tent3 and Tent4, respectively.

In FIGS. 6 and 7, four tents 752, 758, 773 and 778 are shown, each representative of its respective category. However, these category leading tents are chosen differently for emails sent to the control and test groups.

For the control email and its corresponding featured webpage, representative tents 752, 772, 758 and 778 are selected by a human based on current reviews and overall popularity. Thus, one popular tent is selected as a representative tent for each category and shown to all members of the control group.

However, for the test group, the four featured tents 752, 772, 758 and 778 are personalized by dynamically selecting them for each user just prior to sending out the emails. For use case, the ranking server 151 can be used to perform this personalized selection based on updated reviews occurring after the human-selected popular tents were finalized. The ranking server 151 can also access updated online statistics which may change the ranking order based on popularity. Online activity can include recent user transactions and browsing history in which a user may have spent significantly more time browsing a particular tent or tents online. Many other types of automated analysis can be applied to ranking products on a personalized basis, including analyzing each visitor's past and current interactions with the website via online web browsing, email, mobile device applications and phone calls.

In this scenario, potential new site visitors are allocated into two equal groups, neither of which has visited the website for at least a year. One group is the test group and receives the dynamically generated personalized email. The other group is the control group and receives the control email which is the same for all recipients in the control group. Both will be initially presented with the webpage 2100 featuring the same tents as shown in their respective emails. The test is run for a one year period starting with the date when the emails were sent out, but could be run for a week, a month, a quarter or a range of one, two or three weeks, months or quarters.

The test list used for the personalized email can be compiled for all users, customized on a per user basis and even updated prior to sending it to each user so as to be as up-to-date as possible. Last minute updates can be done using the user and object data server to accept and store data from incoming data streams in a cache accessible to the ranking server. The ranking server can use this information to override corresponding portions of the model dataset when performing ranking calculations.

The effectiveness of the email campaign in this example, can be tracked and measured while the campaign is in progress. Additionally, if useful trends or specific insights emerge during the campaign, the remainder of the campaign may be adjusted to further improve results by altering the test stimulus dynamically.

Responses to the emails can be tracked and correlated to individual recipients. For instance, each email can be tagged with a unique identifier which is stored in a database and associated with the addressee, who also has a unique identifier stored in a database. When the recipient email system loads images into the email for viewing, a request is sent to a host server to download that image. The one or both identifiers are sent as part of the request to a host server, which then logs or forwards it to be saved into a database and associated with the corresponding recipient's ID. In addition, the identifier can be sent when a recipient clicks on a link in the email that invokes a browser session via the host server. Email tracking can also be adapted to work with applications on other devices that invoke a web application, instead of a browser.

When a prospective user accesses the website, their unique ID is assigned or obtained. If they used a hyperlink in the email that was sent, then their ID can be obtained from that link. If they used a link from another source, perhaps a social media site, then one or more identifiers may be available from that site. If they login, their ID is part of the login process. In other cases, it may not be possible to immediately identify a user and an anonymous ID will be assigned with the intent to reconcile it at a later time. This ID can be stored in a cookie. A reconciliation of an anonymous user after positive identification may result in the user being excluded from a user acquisition test, if the newly identified user was previously known per the user database 161 or was already a user.

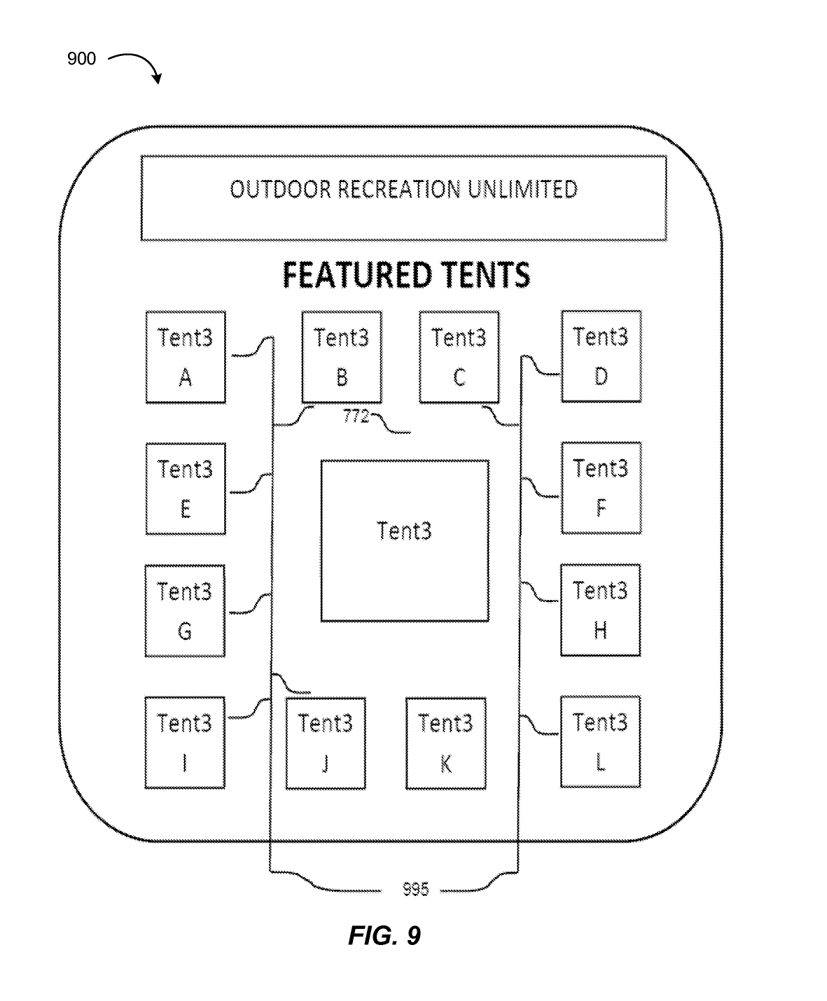

Once a user is identified, if their user ID is associated with the email campaign then he will be allocated to either the test group or the control group. Users in both groups are always presented with the featured tent landing page 800 in FIG. 8. If the user selects a category by clicking on its representative image 752, 772, 758 or 778, that category webpage 900 is presented as shown in FIG. 9. In this example the tent 3 category is used.

The tent 3 representative tent 772 corresponding to the user's email 772 is surrounded by the current top ten tents 995 from the tent 3 category, excluding the representative tent 772. These top ten tents are always the same the control group and for purposes of this example they can be selected by a human editor.

However, for the test group the top ten tents can be dynamically selected by the ranking engine just prior to presenting them. There are many ways to rank these and for this example, the top ten are selected based on a combination of visitor viewing frequency and weighted number of orders by visitors from both the control and test groups from the start of the testing period. Many other approaches are possible to dynamically ranking items in any given category, some of which are identified above.

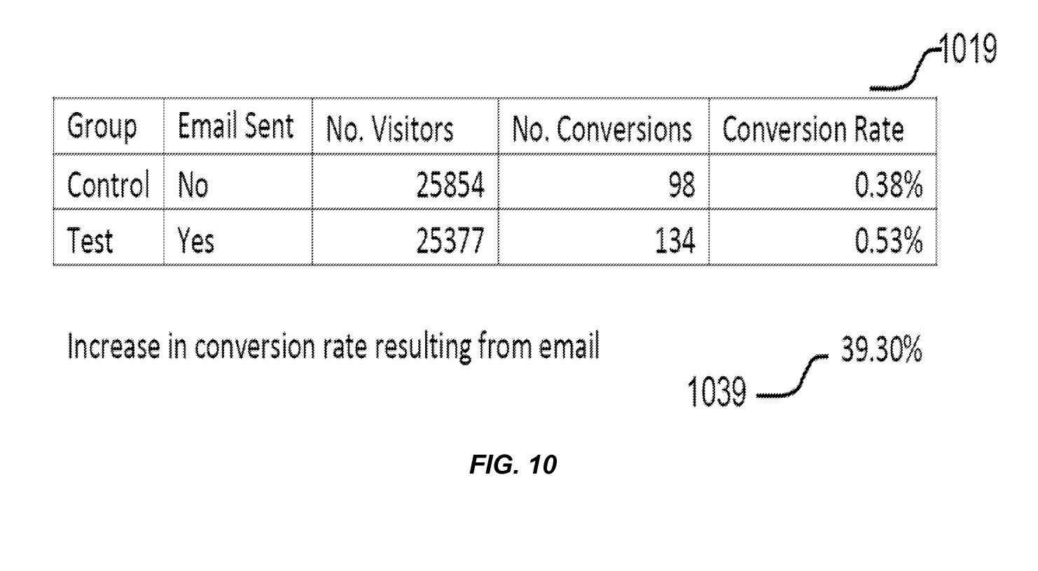

The results of the testing in this example scenario are given in the table in FIG. 10. Conversion rates 1019 are calculated as follows:

conversion rate=(no. of conversions)/(no. of visitors)

Conversion in this example occurs when a perspective user places an order. In this example there is a significant increase of 39.30% in the conversion rate 1039 between the control and test groups. This indicates that the email campaign was successful in its attempt to acquire new users.

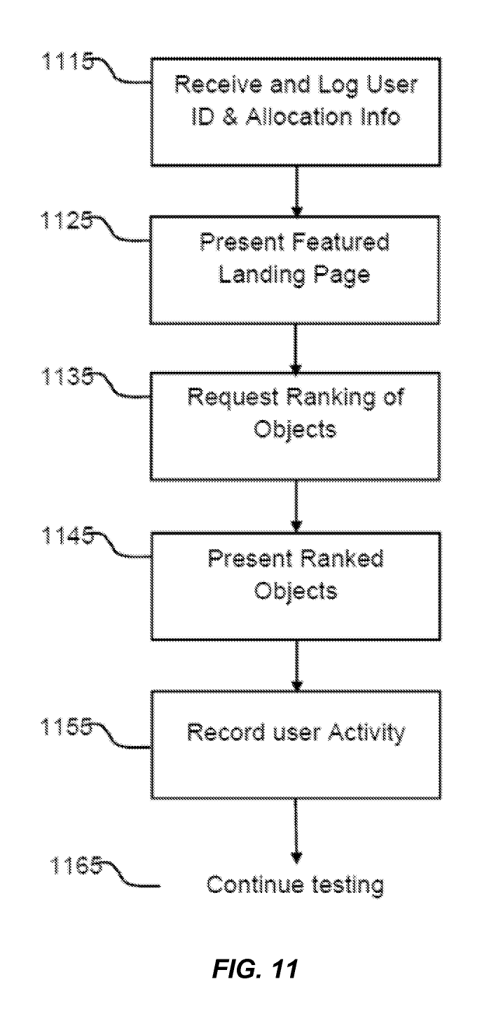

FIG. 11 is a flowchart of the testing and ranking process used in this example. In 1115, a user's ID and allocation information is received, processed and logged by the test server 161 in FIG. 1A into the test plan and sampling DB 185. If the user arrived at the website via an email link or can be otherwise correlated to the email campaign of this example, then the user is allocated to the test group. Otherwise the user is allocated to the control group.

When the user arrives he is presented 1125 with the featured landing page 800 from FIG. 8. After selecting one of the tent categories 752, 758, 772 or 778, that category is dynamically expanded, using additional tents selected by the ranking server 151 at 1135. Preferably, the additional tent selection takes into account update information about the user's browsing and other activities, but the additional tents can be selected at the same time as the representative tents. The resulting ranked objects, the top ten tents 995 from category 3 in this example, are presented as shown in FIG. 9 along with the featured item 972.

In this example, the dynamic ranking of objects can be based on the number of views and orders received, and is performed in real time by the ranking server 151 prior to presenting the ranked objects at 1145. Other ranking approaches include accepting third party ranking data on potential new users so that the models can incorporate the data in advance of the new users visiting the site. After ranked objects are presented to the user, their activity is recorded at 1155 and AB testing 1165 is continued.

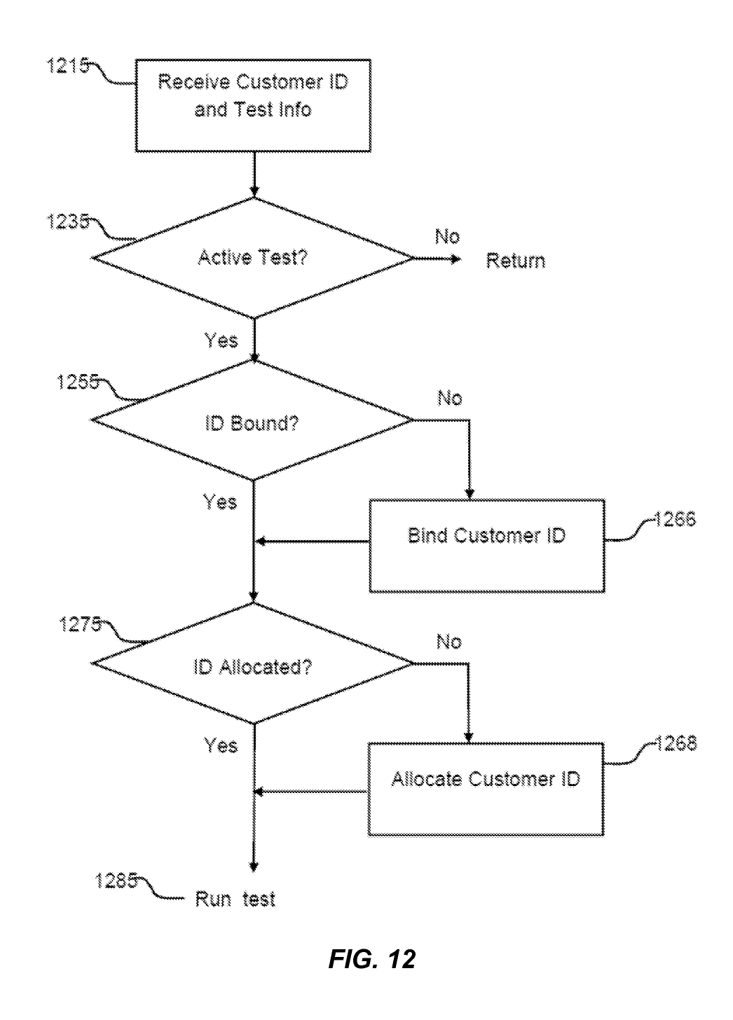

FIG. 12 is a flowchart of the user ID binding and allocation process. In this example, users are assigned both a master ID and one or more anonymous IDs which are mapped to each other. This may result from the need to store browser session information for the user using a cookie or equivalent. If a particular user happens to have multiple browser sessions open, then he may have multiple anonymous IDs. In order for the allocation process to consistently allocate a user during an AB test, the user's master ID can be used and mapped to the anonymous IDs.

In 1215 of FIG. 12, a user's master ID and/or anonymous ID are received. The test name, which can refer to the control or any of the test versions being run, is also received. In 1235, if the specified test name is active then the user's browser receives the webpage corresponding to that test name, otherwise the process returns and the user does not participate at this time in this test.

The user's master ID and/or anonymous ID are checked at 1255. They are bound at 1266, or mapped, to each other if not already bound so that the user's activity can be consistently tracked.

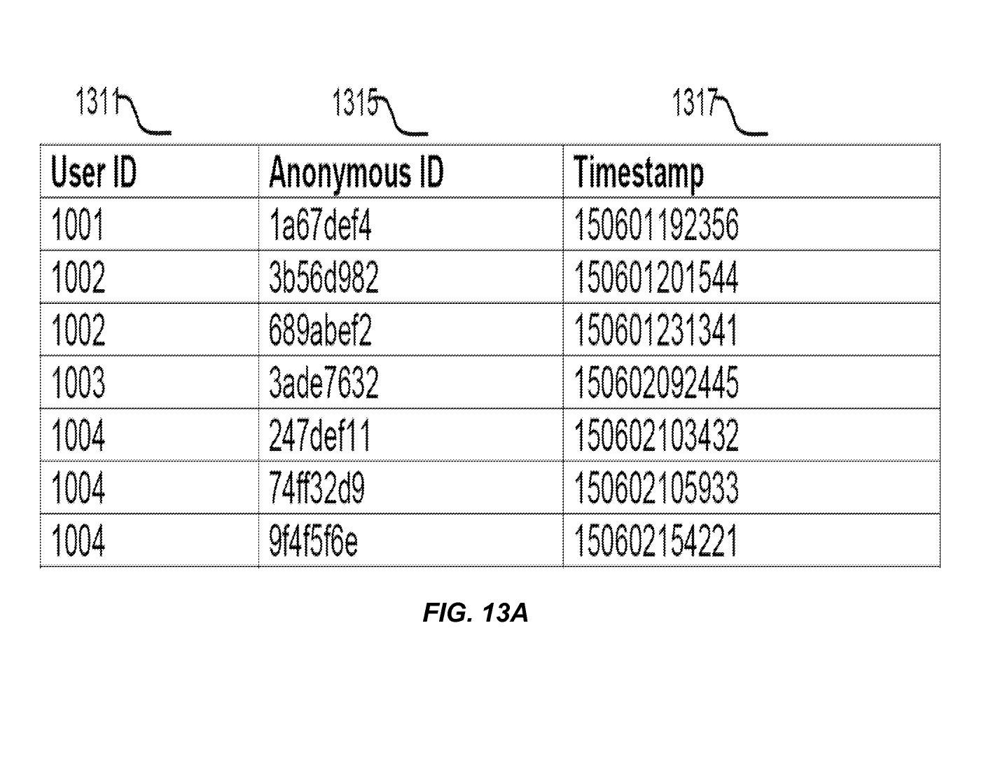

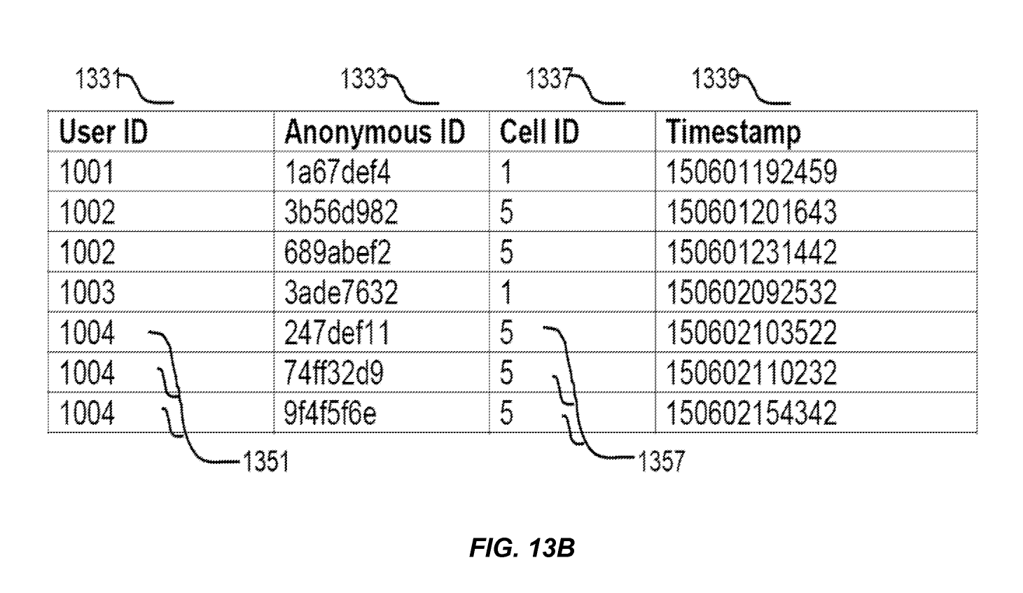

If the user has not yet been allocated, then he is randomly allocated at 1268 to either a test or control cell. In this example, the user ID 1004 is allocated to Test 5 (cell 5 as shown in 1357 FIG. 13B) for this AB test.

FIG. 13A is an example data structure which shows the bindings of user IDs to anonymous IDs in temporal order. Although there are only seven entries in this data structure, only four unique user IDs are shown in 1311 the leftmost column: 1001, 1002, 1003 and 1004. This is a result of user IDs 1002 and 1004 having multiple anonymous IDs, each of which is unique, as shown in the middle column 1315. The rightmost column 1317 shows the times at which the bindings between each user ID and one of its corresponding anonymous IDs was established. For ease of explanation in this example, the user IDs are sequential and have been assigned 8 byte hexadecimal anonymous IDs and 12 byte timestamps. However, any method of assigning unique IDs may be used including assigning sequential numbers which do not repeat or generating unique random numbers such as UUIDs, which are randomly generated hexadecimal numbers usually 128 bytes in length.

FIG. 13B is an example of a data structure for storing allocated users. It shows user IDs 1331, anonymous IDs 1333, cell IDs 1337 and timestamps 1339 at which each of these user allocation table entries was made. This example also illustrates how a particular user is always allocated to the same cell regardless of how many different anonymous IDs he may have in order to maintain consistency in the testing process. User ID 1004, item 1351 in FIG. 13B, exemplifies this by being consistently allocated to cell ID 5, item 1357 in FIG. 13B.

After users are allocated their activity can be tracked and recorded. The test plan and sampling DB 185 can store the activities of users for later analysis. The activities can include details as fine as keystrokes and mouse clicks that provide a comprehensive record of a user's browsing activity. They may also include browsing sequences, some of which may conclude with a transaction. Alternatively or in addition, if a user responds verbally to a presentation that verbal response may be stored. In another implementation, a user may be asked to press a physical control, for instance a button, or otherwise indicate a selection or preference which can be captured. User activity can also be captured external to the test plan and sampling DB 185 by a web agent or other monitoring process which can send it to the user and object server for validation and subsequent storage in the user and object datastore 168. This information can then be accessed by the model generator 149 and used to generate models for use on a per-user or aggregate basis for a group of users.

Similarly, the test plan and sampling DB 185 can store descriptions of tests, including test data, test selection and duration, additional ranking criteria, online service information, user allocation rules, metrics and results associated with individual tests, including new visitor acquisition, click through rates, conversion rates, etc. This information can also be supplied externally to the user and object server 389. Note that allocation may be based on any criteria deemed relevant, including gender, age, income, location, previous activity history. Alternatively, users may be allocated randomly according to a ratio or percentage. In a more sophisticated implementation, users may be categorized according to pre-defined criteria and then randomly assigned to a test cell or control cell in a balanced fashion. Thus, if the criterion were average income, then as long as the average income in each cell were similar, these would be balanced with respect to the pre-defined criteria. This criterion could optionally be combined, for example, with a ratio of users between a test cell and a control cell: for instance, 20 percent of the users could be assigned to the test cell and 80 percent to the control cell. Balancing the user populations in this way for the test and control cells can produce more meaningful results for later comparison in measuring the performance of the web service being tested.

In another implementation, multiple test cells may be used to conduct multivariate tests and rankings that can help to isolate the impact of different services or various aspects of the same service. An example of the latter would be to provide one control cell and three test cells, with each of the test cells featuring different image placements: one gender-based, one location-based and one based on previous browsing activity.

Multivariate tests may be run at different levels of granularity. A fine grained test could for example change only one aspect of a webpage such as the title. Conversely, an example of a coarse grained test is one in which several aspects are changed: title, image sorting and placement, background colors and so forth. This can even be extended to swapping entire groups of webpages in a test against those in a control. The technology disclosed includes the capabilities to handle all of these cases and more.

In another implementation, user allocation can be done dynamically rather than pre-defined. For instance, if specific metrics are being currently measured for a particular test cell and it reaches a certain threshold for a given online service being tested, then all subsequent users may be dynamically allocated to another online service while retaining the same control cell and its users as a reference. This approach can allow testing and comparison of multiple web services which have all attained a given threshold of measured performance.

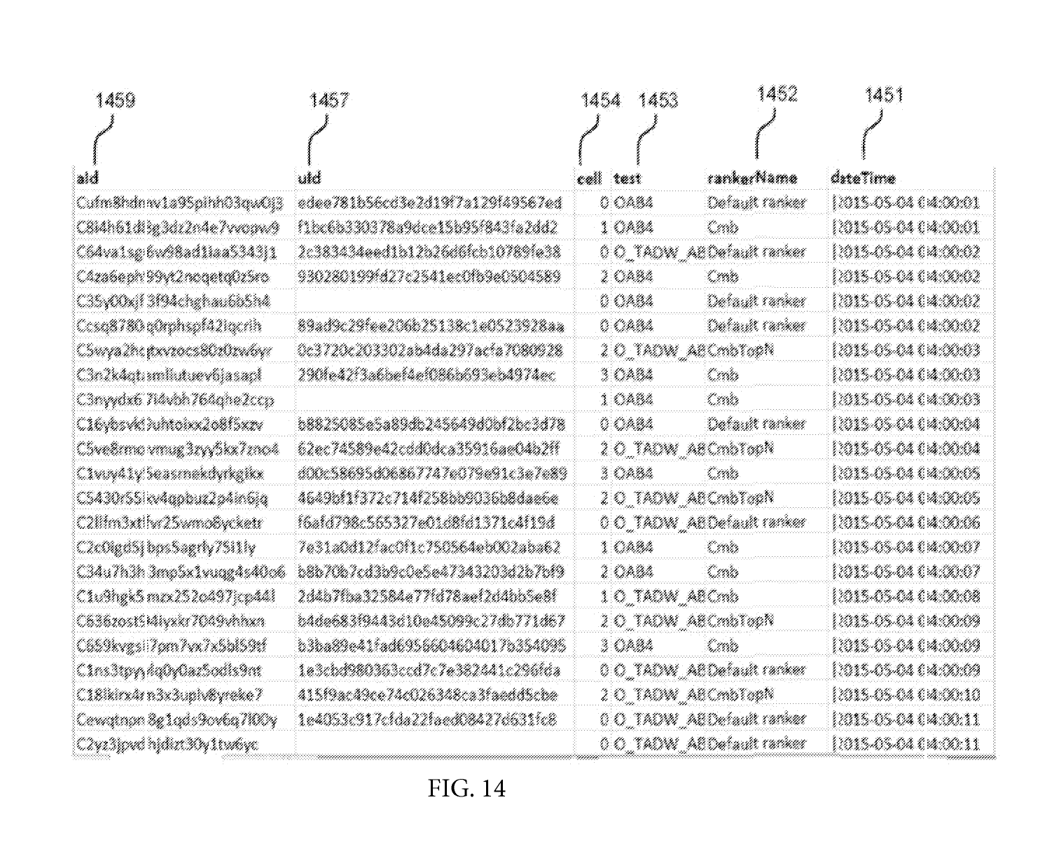

FIG. 14 an example of activity data that includes ranking information where the columns are as follows:
aid 1459: Anonymous ID of a user
uid 1457: Master ID of a user
cell 1454: Cell to which this user was allocated
test 1453: Name of the AB test
ranker name 1452: Ranking application for the allocated cell
dateTime 1451: Timestamp when the allocation call happened

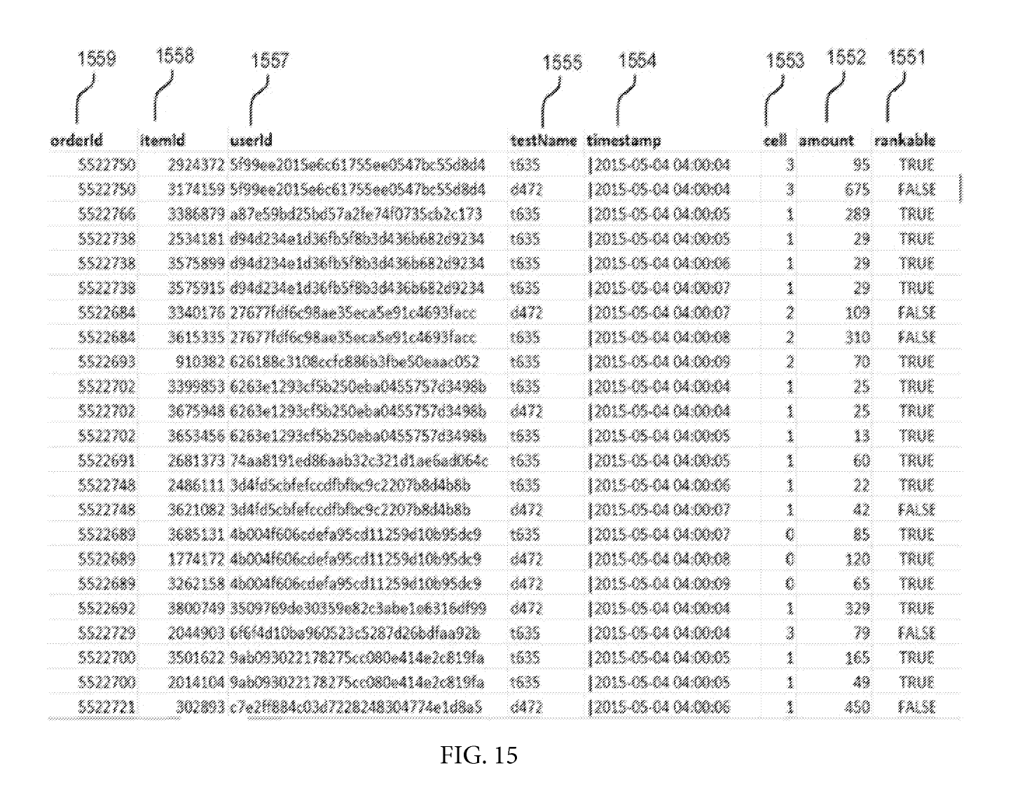

FIG. 15 is an example of activity data that contains metrics data associated with user allocations, where the columns are as follows:
orderId 1559: ID of an order
itemId 1558: ID of the item ordered
userID 1557: Master ID of the user who made the order
testName 1555: Name of the associated AB test
timestamp 1554: Date and time at which order was placed in a standard time format such as UTC time.
cell 1553: Cell to which this user was allocated
amount 1552: amount of the order
rankable 1551: If true, then this order is associated with the target application and should be included in ranking calculations, otherwise false.

The target application is ranking products using the ranking server 151 in FIG. 1A for some webpages in this example table. When a user visited those webpages and ordered some items, they were “rankable.” If the same visitor ordered other items by phone call, for instance, those were not rankable.

The activity data and metrics captured in tables like the brief examples in FIG. 14 and FIG. 15 provide a basis for ranking as well as auditing the incremental value of an online service as per the associated metrics. The activity can include any level of detail desired, for example at a website: recording each user keystroke or mouse click, to recording website pages browsed, selections made by a user and transactions made by a user.

User activities need not be restricted to online website interaction within the context of the internet or other communications network. For instance, an alternate implementation can capture interactions at a physical location in a store providing an interactive display: in such an environment, the user may perform actions, including selections and financial transactions, via physical controls, a voice interface or a mobile device such as a cellphone.

The ranking results provided by the ranking server 151 reflect the relative value of different online services being tested and can be used to continually improve performance as they are integrated into models generated by the model generator 129.

### Some Particular Embodiments

One implementation of the technology disclosed includes a computer-implemented method of comparing item rankings used in web app presentation. As claimed, a “web app” is inclusive of web applications and web sites and covers content delivery to apps on mobile devices, to apps adapted to run on desktop machines or workstations, and to browsers. Being applied to testing or monitoring, this method is repeatedly applied to at least 50 users to whom content is directed. The method can be described from the perspective of a computer-implemented test system or an app server that invokes the test system. In this description from the test system perspective, the method includes receiving electronically a proposed list or a reference to the proposed list of items to feature in a web app, with a control ordering and user correlation data. For each user correlation data, determining according to a test plan whether to return a control list, with the items in the control ordering, or an improved list, with ranked items. In this sense, a test plan can include a monitoring plan that occasionally or periodically reintroduces a control ranking to determine the ongoing performance of a so-called test ranking that is being monitored. The method also includes returning a return list responsive to the proposed list, containing either the control list or the improved list and reporting for the web app a distribution of the return lists with the user correlation data for each return list. The reporting can be internal, for the test system's later analytical use and, optionally, to an app server or a delegate of the app server from which the proposed list and user correlation data was received. The method also includes accessing one or more performance metrics bound by the correlation data to the return lists, wherein the performance metrics indicate user reactions to the return lists, and generating an report indicating the impact of at least one ranking strategy in the test plan on the user reactions to the repeated return lists.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations, such as the test system perspective on comparing item rankings used in web app presentation.

The user correlation data can be selected from a group including user identifier, authenticated user id, device id, and credit card number. Preferably, user attributes are linked to the user correlation data. Optionally, a user name is also linked to the user correlation data, but machine-generated ranking depends on user attributes rather than user names.

The correlation data for users can be received in a batch, for email campaigns, for instance, or received user-by-user, with the return lists are returned in real time, as users are requesting content.

The return list can be shorter than the control list and include preferred items to feature.

Reporting of the distribution of users to control and test groups can include returning with the return list an auditable flag of whether the return list paired with the user correlation data is a control list or an improved list. Or, the reporting of the distribution can include periodic batch reporting of the auditable flag. The auditable flag can be Boolean or it can identify a control or test cell or ranking strategy. The report of the distribution and the generated report of the impact of ranked lists are combined in a single report.

The method can further include generating the report as receiving the proposed lists of items and returning of the return lists is ongoing. In some implementations, the method includes updating parameters applied to ranking of the proposed list of items and modifying the test plan and recording a starting mark for the modified test design, without suspending the test. The test continues receiving the proposed lists of items and returning of the return lists using the modified test plan. In other implementations, a command directs suspension of testing to generate a report during the suspension, update parameters and modify before resuming the delivery of improved lists using the modified test plan.

Some implementations use the user correlation data to access user demographic and activity information to use in preparing the ranked return list. This data can include display context, such as smart phone, tablet, mobile or desktop category and device type. It can include user level of activity, spending patterns and other kinds of activity that vary within classic personal characteristic demographics. It can take into account user demographics, such as users who subscribe to a magazine in addition to requesting online content display site. The user activity information can be used to compare ranking performance of frequent visitors versus occasional or new visitors.

When the metrics include click-through data, the user correlation data can be leveraged to calculate improved click-through performance for one or more list ranking strategies in the test design, as compared to the control ordering.

The correlation data can be used to calculate improved conversion performance for one or more list ranking strategies in the test design, as compared to the initial ordering. Similarly, it can used to calculate margin dollars and contribution to margin of ranking strategies. In some implementations, higher margin items may be ranked for presentation ahead of lower margin items, with margin measured as a percentage or actual amount. The correlation data can be to calculate improved user acquisition performance for one or more list ranking strategies. For instance, orders by new users.

Applying the method and any of its additional features, multiple independent entities can be involved. In this sense, independent means operated separately, belonging to different corporate entities. The entities can be offer alternative ranking services, for instance, one of which will be selected as superior and used by an app server to rank objects. In this scenario, a first entity can determine the initial ordering; and a second entity, independent of the first entity, can determine a ranking strategy. A third entity, independent of the first and second entities, can correlate the performance metrics to generate the report indicating success or failure of the second entity's ranking strategy. Independence of the third entity reduces potential bias.

In another multi-entity scenario, a first entity can determine the initial ordering and a second entity, independent of the first entity, can both determine a ranking strategy and correlating the follow-through data to generate the report indicating success or failure of the second entity's ranking strategy. A service fee of the second entitigy can be based at least in part on improved performance in case of the success of the ranking strategy.

Preferably, ranking of items or objects is repeated many more times than 50. For instance, at least 5,000 times or 5,000 times in 24 hours. Instead of 5,000, the number of repeated instances can be at least 50,000 or 500,000 or 5,000,000.

The technology disclosed can be applied to multivariate analysis of multiple ranking strategies in the test plan and multiple characteristics of site visitors.

The implementations and optional variations described above can be restated from the perspective of the app server, what it sends to and receives from a test server, both as test stimulus and result reporting. The app server's perspective also can include receiving auditable identification of users subject to control or test ranking.

Other implementations may include a computer readable storage medium storing instructions executable by a processor to perform a method as described above. In this sense, the computer readable storage medium excludes transitory wave forms and signals. While signals can be used to deliver instructions executable by a processor, the computer readable storage medium refers to a memory that holds the instructions, rather than a signal that transmits them. Yet another implementation may include a system including memory and one or more processors operable to execute instructions, stored in the memory, to perform a method as described above.

While one or more implementations have been described by way of example and in terms of the specific embodiments, it is to be understood that implementations of the technology disclosed are not limited to these specific embodiments. It is to be understood that the above description is intended to be illustrative, and not restrictive.

We claim as follows:

1. A computer-implemented method of comparing item rankings used in web app presentation, wherein web app is inclusive of web applications and web sites, including:
repeatedly, for at least 50 users,
receiving electronically a proposed list or a reference to the proposed list of items to feature in a web app, with a control ordering and user correlation data;
for each user correlation data, determining according to a test plan whether to return a control list, with the items in the control ordering, or an improved list, with ranked items; and
returning a return list responsive to the proposed list, containing either the control list or the improved list;
reporting for the web app a distribution of the return lists with the user correlation data for each return list; and
accessing one or more performance metrics bound by the correlation data to the return lists, wherein the performance metrics indicate user reactions to the return lists, and generating an report indicating the impact of at least one ranking strategy in the test plan on the user reactions to the repeated return lists.

2. The computer-implemented method of claim 1, wherein the correlation data for the at least 50 users is received in a batch.

3. The computer-implemented method of claim 1, wherein the correlation data for the at least 50 users is received user-by-user and the return lists are returned in real time, as users are requesting content.

4. The computer-implemented method of claim 1, wherein the return list is shorter than the control list and includes preferred items to feature.

5. The computer-implemented method of claim 1, wherein the reporting of the distribution includes returning with the return list an auditable flag of whether the return list paired with the user correlation data is a control list or an improved list.

6. The computer-implemented method of claim 1, wherein the reporting of the distribution includes periodically returning in batches the auditable flag of whether the return lists are included the control list or the improved list.

7. The computer-implemented method of claim 1, wherein the report of the distribution and the generated report of the impact of ranked lists are combined in a single report.

8. The computer-implemented method of claim 1, further including:
generating the report as receiving the proposed lists of items and returning of the return lists is ongoing;
updating parameters applied to ranking of the proposed list of items;
modifying the test plan and recording a starting mark for the modified test design; and
continuing with receiving the proposed lists of items and returning of the return lists using the modified test plan.

9. The computer-implemented method of claim 1, further including:
using the user correlation data to access user demographic and activity information to use in preparing the ranked return list.

10. The computer-implemented method of claim 1, further including:
wherein the metrics include click-through data, using the user correlation data to calculate improved click-through performance for one or more list ranking strategies in the test design, as compared to the control ordering.

11. The computer-implemented method of claim 1, further including:
using the correlation data to calculate improved conversion performance for one or more list ranking strategies in the test design, as compared to the initial ordering.

12. The computer-implemented method of claim 1, further including:
using the correlation data to calculate improved customer acquisition performance for one or more list ranking strategies in the test design, as compared to the initial ordering.

13. The computer-implemented method of claim 1, further including:
a first entity determining the initial ordering; and
a second entity, independent of the first entity, determining a ranking strategy; and
a third entity, independent of the first and second entities, correlating the performance metrics to generate the report indicating success or failure of the second entity's ranking strategy.

14. The computer-implemented method of claim 1, further including:
a first entity determining the initial ordering; and
a second entity, independent of the first entity, determining a ranking strategy and correlating the follow-through data to generate the report indicating success or failure of the second entity's ranking strategy.

15. The computer-implemented method of claim 1, further including:
a first entity determining the initial ordering; and
a second entity, independent of the first entity, determining a ranking strategy and correlating the follow-through data to generate the report indicating success or failure of the second entity's ranking strategy and calculating a service fee based at least in part on improved performance in case of the success of the ranking strategy.

16. The computer-implemented method of claim 1, further including:
repeatedly, at least 5,000 times in 24 hours, receiving the proposed list of items to feature in the web app, with the initial ordering and the user correlation data; and
reporting, according to the test design, after a predetermined number of return lists have been returned.

17. A computer readable storage medium impressed with computer program instructions that, when executed on a process, carry out a method of comparing item rankings used in web app presentation, wherein web app is inclusive of web applications and web sites, including:
repeatedly, for at least 50 users,
receiving electronically a proposed list or a reference to the proposed list of items to feature in a web app, with a control ordering and user correlation data;
for each user correlation data, determining according to a test plan whether to return a control list, with the items in the control ordering, or an improved list, with ranked items; and
returning a return list responsive to the proposed list, containing either the control list or the improved list;
reporting for the web app a distribution of the return lists with the user correlation data for each return list; and
accessing one or more performance metrics bound by the correlation data to the return lists, wherein the performance metrics indicate user reactions to the return lists, and generating an report indicating the impact of at least one ranking strategy in the test plan on the user reactions to the repeated return lists.

18. The computer readable storage medium of claim 17, wherein the correlation data for the at least 50 users is received user-by-user and the return lists are returned in real time, as users are requesting content.

19. The computer readable storage medium of claim 17, wherein the return list is shorter than the control list and includes preferred items to feature.

20. The computer readable storage medium of claim 17, wherein the reporting of the distribution includes returning with the return list an auditable flag of whether the return list paired with the user correlation data is a control list or an improved list.

21. The computer readable storage medium of claim 17, further including instructions to implement:
generating the report as receiving the proposed lists of items and returning of the return lists is ongoing;
updating parameters applied to ranking of the proposed list of items;
modifying the test plan and recording a starting mark for the modified test design; and
continuing with receiving the proposed lists of items and returning of the return lists using the modified test plan.

22. The computer readable storage medium of claim 17, further including instructions to implement:
using the user correlation data to access user demographic and activity information to use in preparing the ranked return list.

23. The computer readable storage medium of claim 17, further including instructions to implement:
a first entity determining the initial ordering; and
a second entity, independent of the first entity, determining a ranking strategy and correlating the follow-through data to generate the report indicating success or failure of the second entity's ranking strategy and calculating a service fee based at least in part on improved performance in case of the success of the ranking strategy.

24. At least one device including at least one processor, a memory coupled to the processor, and instructions that, when executed, cause the processor to carry out a method including:
repeatedly, for at least 50 users,
receiving electronically a proposed list or a reference to the proposed list of items to feature in a web app, with a control ordering and user correlation data;
for each user correlation data, determining according to a test plan whether to return a control list, with the items in the control ordering, or an improved list, with ranked items; and
returning a return list responsive to the proposed list, containing either the control list or the improved list;
reporting for the web app a distribution of the return lists with the user correlation data for each return list; and
accessing one or more performance metrics bound by the correlation data to the return lists, wherein the performance metrics indicate user reactions to the return lists, and generating an report indicating the impact of at least one ranking strategy in the test plan on the user reactions to the repeated return lists.
